(19) United States
(12) Patent Application Publication
(10) Pub. No.: US 2008/0245419 A1
(43) Pub. Date: Oct. 9, 2008

(54) High-volume axial valve

(76) Inventor: Brian D. Schlepp, Yakima, WA (US)

Correspondence Address: STRATTON BALLEW, 213 S 12TH AVE, YAKIMA, WA, 98902, US

(21) Appl. No.: 11/732,263

(22) Filed: Apr. 3, 2007

(51) Int. Cl. F16K 1/12

(52) U.S. Cl. 137/219

(57) ABSTRACT

An axially oriented valve for regulating the flow of a fluid, to provide an efficient and quick cycling control of a high volume of air or other fluid flow through the valve, with a minimum of flow resistance when the valve is in the open position. The axial valve includes a valve body having a valve inlet, a valve outlet, and a valve chamber. An annular shaped valve seat within the valve chamber is positioned proximate to the valve inlet, and a piston is contained within the valve chamber, movable within the valve chamber, the piston movable along the axis of the valve, between an open position and a closed position. The piston includes an internal piston chamber and a head seat sealable upon the valve seat with the piston in the closed position, and the piston actuateable between the open valve position and the closed valve position.

### TECHNICAL FIELD

The invention relates to an axially oriented valve for regulating the flow of a fluid. More particularly, the axial valve of the present invention provides an efficient and quick cycling control of a high volume of air or other fluid flow through the valve, with a minimum of flow resistance when the valve is in the open position.

### BACKGROUND OF THE INVENTION

The efficient control of fluid flow through valves is an ongoing challenge in any industrial use requiring quick responses to dynamic process requirements, involving the flow of high volumes of fluids. In general, axial types of valves have inherent advantages over side actuating valves, in that the axial valve is typically more compact, compared to most other conventional valve configurations, and potentially functions with lower friction or pressure losses through the valve. These lower resistances to flow through the valve are typically realized by minimizing changes in flow direction and restrictions in the valve that result in pressure drops through conventional valves equipped with “stemmed” controlling components.

“Piloted” valves are often needed in automated processes. The operation of a piloted valve is remotely activated from a central, computer or microprocessor controller. The electro-mechanical interface between the valve and the programmable controller may include a servo, a solenoid or some other appropriate device, as known to those skilled in industrial process controls.

To realize economic advantages of increasing process speed in an effort to maximize production, faster response and on/off cycle times are often demanded for the various mechanical process control components, such as valves. Present advances in manufacturing techniques are limited by the inherent mechanical limitations of conventional valves. As the cycling speed of any particular valve increases, the likelihood of failure and leakage also increases. Even with the conventional axial valve's advantages over non-axial valves, a faster, more reliable and better sealing axial valve is still needed, especially for use in high-speed, automated industrial settings.

The axial valve of the present invention addresses these shortcomings of conventional axial valve designs to provide a superior functioning valve. The aspects and advantages of the invention will become apparent from consideration of the following figures and description.

### BRIEF DESCRIPTION OF DRAWINGS

FIG. 1 is a sectioned side view of an axial valve, according to an embodiment of the invention;

FIG. 2 is a sectioned side view of an axial valve, according to an embodiment of the invention;

FIG. 3 is a sectioned isometric view of an axial valve, according to an embodiment of the invention;

FIG. 4 is a sectioned isometric view of an axial valve, according to an embodiment of the invention;

FIG. 5 is a sectioned side view of an axial valve, according to an embodiment of the invention; and

FIG. 6 is a sectioned side view of an axial valve, according to an embodiment of the invention.

### DETAILED DESCRIPTION OF SPECIFIC EMBODIMENTS

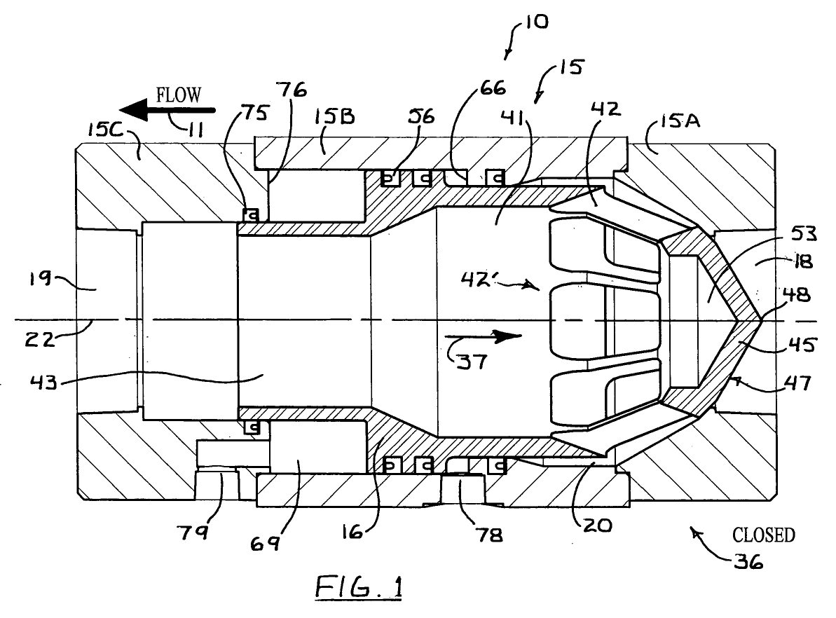

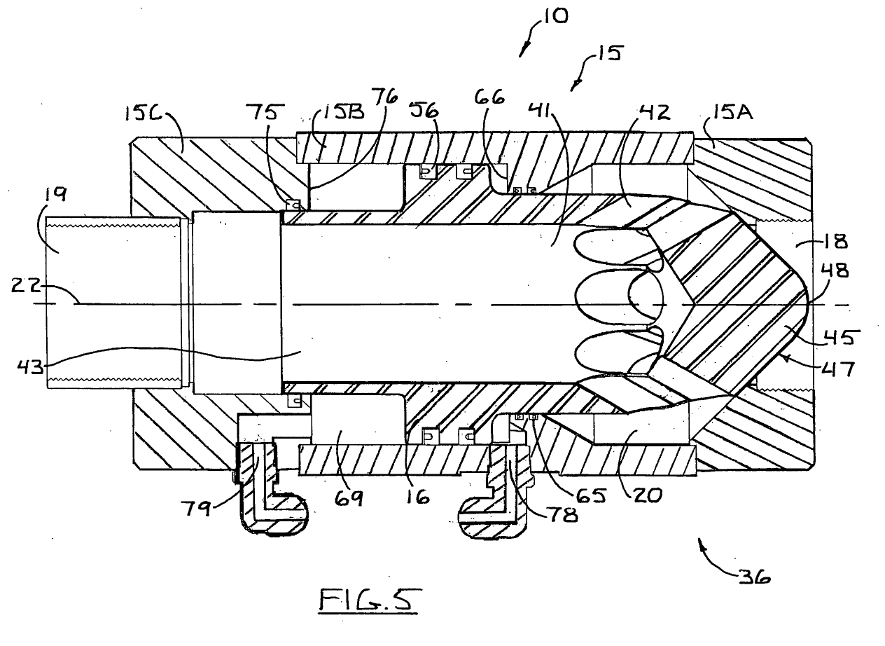

The present invention includes an axial valve 10, for regulating a fluid flow 11 at a high valve cycle rate with a minimum of flow resistance. Preferred embodiments of the axial valve of the present invention are shown in FIGS. 1 through 6. The present invention is well suited for use in the on/off, or 2-way control of high velocity, compressed air, or other gas flows under pressure. These compressed gas systems are generally referred to as “pneumatic” systems. Pneumatic fluids are typically gaseous, but can include pure and component mixtures of gases or aerosols, such as nitrogen, carbon dioxide, oxygen, steam, and fire-extinguishing compounds similar to Halon™. The present invention is well suited for use with remotely operated or “piloted” valves, as opposed to valves actuated by manual or purely mechanically means. The activation or operation of piloted valves is typically accomplished by a pneumatic or hydraulic controller that directs a pressurized stream of a control fluid to the valve, to actuate the valve. Piloted valves are typically “stemless” and lack a rotatable stem, which is oriented conventionally at a right angle to the flow through the valve. The conventional valve stem is turned manually, or by a servo or similarly acting device, to open and close the valve.

As shown in FIGS. 1 through 6, a preferred embodiment of the axial valve 10 includes a valve body 15 that houses a piston 16, within. The valve body has a valve inlet 18, a valve outlet 19 and a valve chamber 20 within the valve body. The valve chamber receives the piston, and the piston is able to move within the valve body, along a valve axis 22. The fluid flow is receivable into the valve inlet, and the fluid flow dischargeable through the valve outlet.

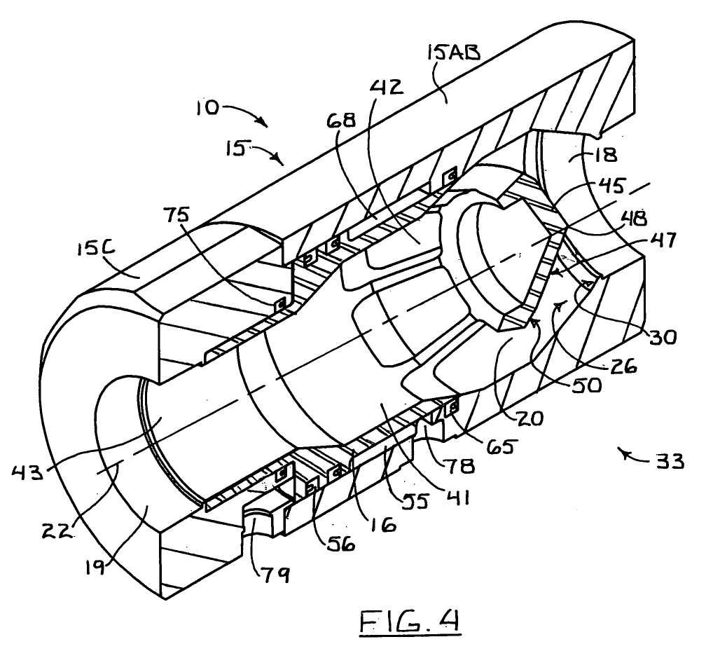

The valve chamber 20 of the valve body 15, also includes a chamber surface 26. A portion of the chamber surface is a valve seat 30. Specifically, the valve seat is located on the chamber surface, within the valve chamber 20 of the valve body. Preferably, the valve seat is positioned proximate to the valve inlet 18. As detailed in FIG. 4, the valve seat is most preferably formed or milled in the shape of a ring, and this ring-shaped valve seat is preferably centered about the valve axis 22. As discussed later herein, the valve body surface contacts the piston 16 to cutoff fluid flow 11 through the axial valve 10.

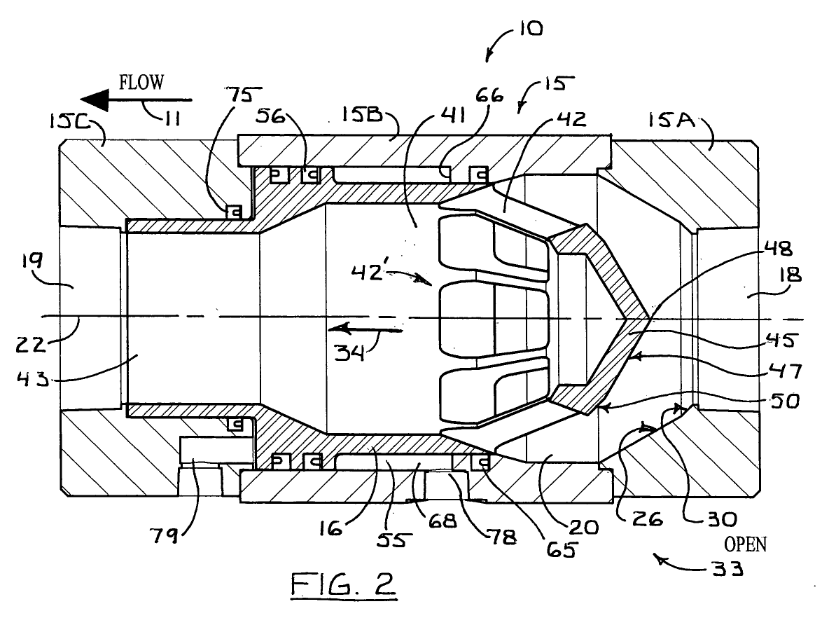

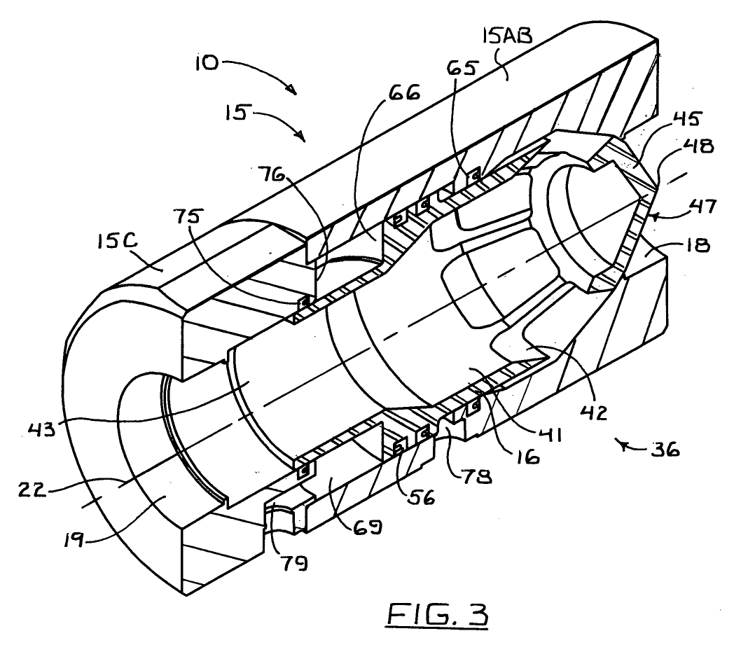

The valve body 15 may be manufactured in two or more component parts, with a preferred three component parts, as shown in FIGS. 1 and 2. The valve body preferably includes an inlet cap 15A, which mounts to a main body 15B. The valve inlet cap includes the valve inlet 18. Additionally, the valve body most preferably includes a valve outlet cap 15C, which also mounts to the main body. The valve outlet cap most preferably includes the valve outlet 19. The valve inlet cap is optional, in that a valve inlet cap and main body 15AB may be manufactured from a single piece of material, as shown in FIGS. 3 and 4. Alternatively, the valve body might be cast as a single unit.

The valve body 15 is preferably manufactured from a light in weight metal alloy. Most preferably all three components of the valve body, including the inlet cap 15A, the main body 15B, and the valve outlet cap 15C, are milled from aluminum that is then hard-anodized. Alternatively, the valve body could be cast from a metal alloy, such as brass, and can be plated to add hardness. Nickle is a common plating employed to increase service life for exposed surfaces, and also reduce friction for surfaces that contact or abrade other surfaces.

To assemble the axial valve 10, the piston 16 is preferably placed within the main body 15B, with the inlet cap 15A already attached. The outlet cap 15C is then attached, holding and containing the piston within the valve chamber 20. The attachments of the inlet cap and the outlet cap to the main body is preferably accomplished with a threaded mounting. However, alternative or supplemental mounting methods may also be employed to attach the inlet and outlet caps to the main body to form the valve body 15, such as bolts, screws, epoxies and welds.

The piston 16 may be manufactured from a single piece of material, or alternatively cast, milled or molded as a single unit, similar to the manufacture of the valve body 15. Preferably, the piston is formed from a solid cast or otherwise extruded block of a mill-able plastic, such as Nylatron® brand of polyamide. Milling the piston from a self lubricating plastic material reduces the weight and expense of the piston as compared to metal equivalents, while increasing service life. With the piston 16 contained or housed within the valve chamber 20 of the valve body, the piston can move within the valve chamber, moving proximately along the valve axis 22. The piston is movable within the valve chamber between an open valve position 33 and a closed valve position 36. As shown in FIGS. 2 and 4, the piston moves in a rearward direction 34, along the valve axis and toward the valve outlet 19 to the open valve position. The piston moves in a forward direction 37 along the valve axis and toward the valve inlet 18 to the closed valve position is, as shown in FIGS. 1 and 3.

As shown in FIGS. 1 through 4, the piston 16 includes an internal piston chamber 41, the internal piston chamber having a piston inlet 42 and a piston outlet 43, all formed as voids or penetrations, within or through the piston. With the piston contained by the valve body 15, as described above, the piston inlet is located proximate to the valve inlet 18 of the valve body. When the piston is in the open valve position, as shown in FIGS. 2 and 4, the piston inlet receives the fluid flow 11 from the valve inlet, into the internal piston chamber. The fluid flow exits the piston through the piston outlet. The piston outlet is located proximate to the valve outlet 19 of the valve body. When the piston is in the open valve position, the piston outlet receives the fluid flow from the internal piston chamber, to exit from the valve outlet of the valve body.

Most preferably, the piston inlet 42 of the piston 16, is a plurality of piston inlets 42′, or “inlet ports,” as shown in FIGS. 1 and 2. Eight inlets are a most preferred number of piston inlets, and optimally serve to provide structural strength for support of the sealing head 45 between the ports, while maximizing the combined, cross-sectional area of the piston inlets. In the present description, unless otherwise indicated, the areas of any particular port, inlet or outlet opening is the area at a right angle to flow, or “normal” to the direction of flow. The piston inlet has a cross sectional area normal to a direction of the fluid flow 11 through the piston inlet, and the valve inlet 18 has a cross sectional area normal to the direction of fluid flow through the valve inlet. Most preferably, the cross sectional area normal to the direction of the fluid flow through the inlet piston port is at least the cross sectional area normal to the direction of fluid flow through the valve inlet. With the cross sectional area normal to the direction of the fluid flow through the inlet piston port at least, or greater than, the cross sectional area normal to the direction of fluid flow through the valve inlet, resistance to flow through the piston is minimized, which is a distinct advantage afforded by this preferred embodiment of the axial valve 10.

The overall diameter of the piston 16 about the valve axis 22 is preferably increased, to reduce the frictional resistance and velocity of the fluid flow 11 through the plurality of piston inlets 42′. To accommodate the preferred enlargement of the piston, the volume of the valve chamber 20 is likewise increased to reduce the velocity of the fluid and minimize friction losses as the fluid flows into the valve inlet 18 though the piston inlets. Even without increasing the diameter of the piston to enlarge the total area of the piston inlets, the volume of the valve chamber is most preferably increased, to slow fluid velocity and reduce flow resistance through the piston inlets.

As shown in FIGS. 1 through 6, the piston 16 includes a sealing head 45 located proximate to the piston inlet 42. The sealing head is preferably positioned between the piston inlet and the valve inlet 18. Additionally, the sealing head has a head surface 47, as shown in FIGS. 2 and 4. The head surface includes an axial point 48 located proximate to the intersection of the valve axis 22 with the head surface.

For the axial valve 10 of the present invention, a head seat 50 of the piston 16 preferably contacts the valve seat 23 of the valve body 15, when the piston is in the closed valve position 36. The closed valve position of the piston cuts off the fluid flow 11 to the internal piston chamber 41 from the valve inlet 18. The head seat is a portion of the head surface 47 of the piston and as shown in FIGS. 1 and 3, is preferably a smooth, ring-shaped surface that precisely complements the valve seat 23. Most preferably, the head seat is located on the head surface, between the piston inlet 42 and the axial point 48.

In the closed valve position 36, as shown in FIGS. 1, 3 and 5, the head seat 50 of the piston 16 seals tightly upon the valve seat 30 of the valve body 15, to prevent the fluid flow 11 through the axial valve 10. The valve seat and the head seat are preferably machined to close mating tolerances, with hardened surfaces, most preferably imparted through case hardening, anodizing or alternatively by replaceable seals. Specifically, the closed valve prevents the fluid flow through the piston inlet 42, into the internal piston chamber 41. Furthermore, in the closed valve position, the piston is moved along the valve axis 22, so that the piston is located at its furthest possible advance toward the valve inlet 18 within the valve chamber 20.

In the open valve position 33, as shown in FIGS. 2, 4 and 6, the head seat 50 of the piston 16 is separated from the valve seat 30. In an intermediate valve position, the piston could be located anywhere between the closed valve position 36 and the open valve position. This intermediate position of the piston could be achieved with the axial valve 10 of the present invention, and the intermediate position of the piston may be employed to provide for a lesser or attenuated fluid flow 11, as compared to the fluid flow achieved at the open valve position. However, a most preferred use of the present invention is as a two-position or “on/off” valve, rather than a modulating or multi-position control valve.

The piston 16 of the axial valve 10 could be moved along the valve axis 22 within the valve camber 20 through various alternative mechanisms, such as spring tensioning or hydraulic actuation. A preferred mechanism to provide for actuation of the piston is the use of pneumatic pressure, employing conventional flow controllers and control interfaces well known to those persons skilled in piloted valve control technologies.

For pneumatic pressure actuation of the axial valve 10, an actuation chamber 55, formed between the valve body 15 and the piston 16, is employed. As shown in FIGS. 1 through 6, the actuation chamber is a substantially annular shaped portion of the valve chamber wrapping around the piston, in the void space of the valve chamber formed between the piston and the valve body.

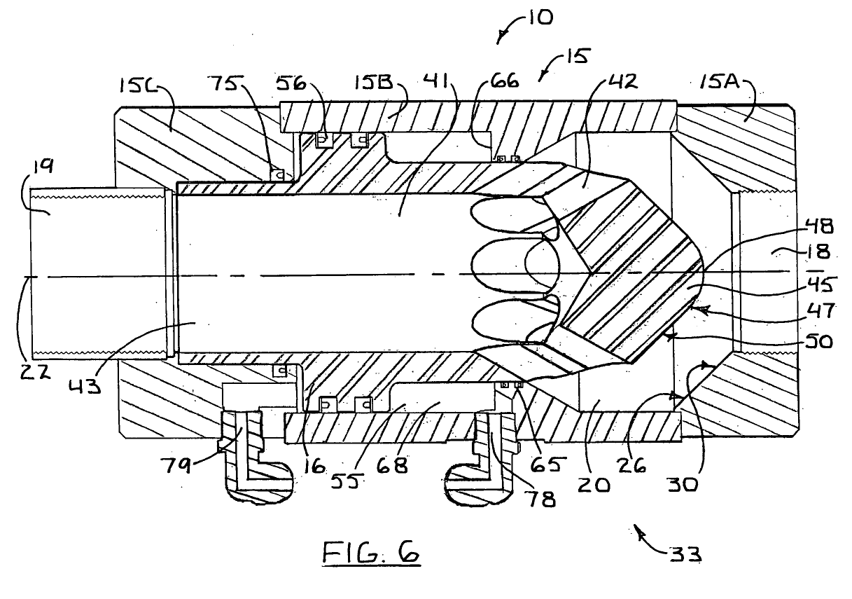

Because of the high strength, yet light in weight materials most used for the piston 16, and the relatively small distance along the valve axis 22, between the open valve position 33 and the closed valve position 36, as compared with conventional valves handling similar rates of fluid flow 11, extraordinarily high cycle times can be achieved with the axial valve 10 of the present invention. An additional saving in the mass of the piston is realized by the enlargement of a head space 53, as shown in FIG. 1. The head space is formed in the internal piston chamber 41 side of the sealing head 45, beneath the head surface. By minimizing the thickness of all piston walls, the mass of the piston is also minimized, thereby minimizing the inertia of the piston, and the force required to actuate the piston at any given speed. FIGS. 4 and 6 show a less preferred embodiment of the axial valve, without an enlarged head space. Closed to open valve stroke times of seventy-five milliseconds have been realized with an axial valve similar in configuration to FIGS. 1 and 2, with a nominal valve inlet 18 diameter of three inches, designed with an enlarged head space, enlarged piston inlets 42 and an enlarged internal piston chamber 41. Other nominal valve sizes, larger and smaller than three inches, could be manufactured that employ the features of the present invention, without undue experimentation.

Most preferably, the piston 16 is actuated by the injection of an actuation fluid 57. The pressurization of the actuation chamber 55 forces the movement of the piston within the valve chamber 20 along the valve axis 22. The actuation fluid may be any hydraulic fluid, or as preferred, a compressed air, as typically utilized in conventional pneumatic actuation systems.

The piston 16 preferably includes a piston ring 56, as shown in FIGS. 1 through 4. The piston ring abuts against the valve body 15, and is closely proximate to the actuation chamber 55. Specifically, the piston ring bridges and provides a seal between the piston and the valve body to prevent the fluid flow 11 from bypassing the piston inlet 42, and importantly to form a piston endwall 60 within the actuation chamber.

The valve body 15 preferably includes an inlet ring 65, as shown in FIGS. 1 through 4. The inlet ring abuts against the piston 16, proximate to the piston inlet 42, when the piston is in the open valve position 33 within the valve body. Like the piston ring 56, the inlet ring is closely proximate to the actuation chamber 55. Specifically, the inlet ring bridges between the valve body and the piston, providing a seal, to prevent the fluid flow 11 from bypassing the piston inlet, and more importantly to form a forward endwall 66 within the actuation chamber, to prevent the actuation fluid 57 from escaping into the valve chamber 20.

The actuation chamber 55 is partitioned by the piston ring 56, which has a forward chamber 68 and a rearward chamber 69, with the volume of each chamber changing as the piston 16 moves along the valve axis 22 within the actuation chamber. The forward chamber is separated from the rearward chamber by the piston ring 56, and the piston ring moves with the piston. With the movement of the piston ring, the volume of the actuation chamber is portioned to either the forward chamber or the rearward chamber.

The valve body 15 also preferably includes an outlet ring 75, a shown in FIGS. 1 through 4. The outlet ring abuts against the piston 16, proximate to the piston outlet 43, especially when the piston is in the closed valve position 36 within the valve body. Specifically, the outlet ring bridges and provides a seal between the valve body and the piston to prevent the fluid flow 11 from bypassing the piston inlet, and more importantly to seal a rearward endwall 76 within the actuation chamber, to prevent the actuation fluid from escaping into the valve chamber 20.

For the present invention, the inlet ring 65 and the outlet ring 75 are both incorporated into the valve body 15. However, as an alternative, these rings could be incorporated into the piston 16, instead. The selection of the seals as embodied in the various rings employed for the axial valve 10, including the inlet and outlet rings, and the piston ring 56, can be made by any person skilled in such seal selections. However, “U-cup” or “U-Packing” types of “gap-less” seals, such as the “8400 series U-Ring seals,” as manufactured by the Parker Hannifin Corporation, of Salt Lake City Utah, USA, are preferred. For the piston ring, two seals arranged in a “double-acting piston seal packing” on the piston, as shown in FIGS. 1 and 2, are most preferred to provide an optimal seal in both the forward direction 37 and the rearward direction 34.

For opening actuation of the axial valve 10, the piston 16 moves in the rearward direction 34 to the open valve position 33, as shown in FIGS. 2 and 4. With the piston in the open valve position, the piston ring 56 partitions the actuation chamber 55 to maximize the volume of the forward chamber 68 and minimize the volume of the rearward chamber 69. To force the movement of the piston to the open valve position, the actuation fluid 57 is injected into the forward chamber through a forward port 78, to pressurize the forward chamber While the forward chamber pressurizes, the air or other actuation fluid already occupying the rearward chamber is allowed to escape from the rearward chamber through a rearward port 79.

For closing actuation of the axial valve 10, the piston 16 moves in the forward direction 37 to the closed valve position 36, as shown in FIGS. 1 and 3. With the piston in the closed valve position, the piston ring 56 partitions the actuation chamber 55 to maximize the volume of the rearward chamber 69 and minimize the volume of the forward chamber 68. To force the movement of the piston to the closed valve position, the actuation fluid 57 is injected into the rearward chamber through the rearward port 79, to pressurize the rearward chamber. While the rearward chamber pressurizes, the air or other actuation fluid already occupying the forward chamber, is allowed to escape from the forward chamber through the forward port 78.

With the pressurization of either the forward chamber 68 or the rearward chamber 69, the piston 16 is actuate-able between the open valve position 33 and the closed valve position 36, respectively. With the pressurization of the forward chamber, the piston travels in the rearward direction 34 to remove the head seat 50 from the valve seat 30. The moment the head seat lifts from the valve seat, the fluid flow 11 floods from the valve inlet 18 into the valve chamber 20, then through the piston inlet 42, and into the internal piston chamber 41, to escape through the piston outlet to the valve outlet 19. With the pressurization of the rearward chamber, the piston returns in the forward direction 37 to mate the head seat to the valve seat to arrest the flow of fluid from the valve inlet into the valve chamber.

In a possible alternative embodiment of the present invention, the axial valve 10 could act as a check valve, to only open if the pressure of the fluid flow 11 into the valve inlet 18 is sufficient to force the piston 16 into the open valve position 33. Resistance to the pressure of the fluid flow on the head surface 47 could be provided by a valve spring located proximate to the rearward chamber 69, and coiling around the piston. In a most preferred alternative of this proposed embodiment, the sealing head 45 would be modified to provide a flattened surface, rather than the preferred conical shape culminating at the axial point 48, as discussed above. With sufficient pressure on the sealing surface, the piston would force the valve spring to compress, as the piston moved along the valve axis 22 in the rearward direction 34. The opened valve then could allow the fluid flow through the internal piston chamber 41, until the pressure on the head surface drooped below the force required to maintain compression on the valve spring. Once the flow pressure drops to this minimum level, the valve spring could recoil to expand and move the piston in the forward direction 37, returning the piston to the closed valve position 36 with the head seat 50 meeting the valve seat 30, to stop the fluid flow through the axial valve.

In an additional proposed alternative embodiment of the present invention, the axial valve 10 could act as a check valve, with fluid flow 11 in the opposite direction shown in FIGS. 1 and 2. In this possible alternative, the valve would only close if the pressure of the fluid flow into the valve outlet 19, now acting as the inlet, would be sufficient to force the piston 16 into the closed valve position 36. Resistive force against the pressure of the fluid flow upon the head space 53 within the internal piston chamber 41, upon the inside of the sealing head 45, could be provided by a valve spring located proximate to the forward chamber 68, and coiling around the piston. With sufficient pressure on the internal side of the sealing head, the piston forces the valve spring to compress, as the piston moves along the valve axis 22 in the rearward direction 34. The closed valve would remain sealed and prevent the fluid flow through the internal piston chamber 41, until the pressure on the head surface dropped below the force required to maintain compression on the valve spring. Once the flow pressure drops to this minimum level, the valve spring would recoil and expand to move the piston in the rearward direction, returning to the closed valve position 36 with the head seat 50 meeting the valve seat 30, to stop the fluid flow through the axial valve. The action of the axial valve 10 for the above proposed additional alternative embodiment of the present invention, with fluid flow 11 in the opposite direction shown in FIGS. 1 and 2, the piston 16 could be actuated by the injection of the actuation fluid 57. Even with the fluid flow into the valve outlet 19, and the fluid flow exiting axial valve through the valve inlet 18. The pressurization of the actuation chamber 55 would force the movement of the piston within the valve chamber 20 along the valve axis 22. As discussed above, the actuation fluid may be any hydraulic fluid, or as preferred, a compressed air, as typically utilized in conventional pneumatic actuation systems.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited but by the following claims, as appropriately interpreted by the doctrine of equivalents.

The following is claimed:

1. An axial valve for regulating a fluid flow, the axial valve comprising:
a valve body, the valve body having a valve inlet, a valve outlet and a valve chamber within the valve body, the fluid flow receivable into the valve inlet, and the fluid flow dischargeable through the valve outlet;
a valve axis connecting the valve inlet center and the valve outlet center;
a valve seat, the valve seat within the valve chamber of the valve body, the valve seat positioned proximate to the valve inlet;
a piston contained within the valve chamber of the valve body, the piston movable within the valve chamber, the piston movable within the valve chamber proximately along the valve axis, between an open valve position in a rearward direction toward the valve outlet, and a closed valve position in a forward direction toward the valve inlet;
the piston including an internal piston chamber, the internal piston chamber having a piston inlet and a piston outlet, the piston inlet located proximate to the valve inlet and the piston outlet located proximate to the valve outlet, and the piston inlet for receiving the fluid flow into the internal piston chamber;
the piston having a sealing head, the sealing head having a head surface, the sealing head of the piston located proximate to the piston inlet, the sealing head including an axial point, the axial point located proximate to the intersection of the valve axis with the head surface of the piston;
a head seat, the head seat including a portion of the head surface of the sealing head of the piston, the head seat located on the piston between the piston inlet and the axial point, and the head seat of the piston sealable upon the valve seat of the valve body with the piston in the closed valve position, to prevent the fluid flow through the axial valve;
the valve body including an actuation chamber, the actuation chamber having a substantially annular shape around the piston;
the piston including a piston ring, the piston ring abutted against the valve body, and the piston ring substantially contained within the actuation chamber;
the actuation chamber having a forward chamber and a rearward chamber, the forward chamber and the rearward chamber separated by the piston ring, and the piston ring movable within the actuation chamber as the piston moves along the valve axis; and
the piston actuateable between the open valve position and the closed valve position, by a pressurizing of the rearward chamber.

2. The axial valve of claim 1, wherein;
the piston of the axial valve is pneumatically actuated between the open valve position and the closed valve position.

3. The axial valve of claim 1, wherein;
the piston inlet is a multiple of piston inlet ports.

4. The axial valve of claim 1, wherein;
the piston inlet port has a cross sectional area normal to a direction of the fluid flow through the piston inlet port, and the valve inlet having a cross sectional area normal to the direction of fluid flow through the valve inlet; and
the cross sectional area normal to a direction of the fluid flow through the inlet piston port is at least the cross sectional area normal to the direction of fluid flow through the valve inlet.

5. The axial valve of claim 4, wherein;
the piston inlet is a multiple of piston inlet ports, and the cross sectional area normal to the direction of fluid flow through the piston inlet port is a sum of each of the cross sectional areas normal to the direction of fluid flow through each piston inlet port.

6. The axial valve of claim 1, wherein;
the piston is movable along the valve axis from the closed valve position, to allow the fluid flow through the axial valve;
the sealing head is substantially conical in shape, and the head seat is a substantially circular surface in form; and
the valve seat is a substantially circular surface in form, to match and seal with the sealing head.

7. An axial valve comprising:
a valve body, the valve body having a valve inlet, a valve outlet, and a valve chamber within the valve body;
a valve axis connecting the valve inlet center and the valve outlet center;
a valve seat, the valve seat within the valve chamber of the valve body, the valve seat positioned proximate to the valve inlet;
a piston contained within the valve chamber of the valve body, the piston movable within the valve chamber, the piston movable within the valve chamber proximately along the valve axis, between an open valve position in a rearward direction toward the valve outlet and a closed valve position in a forward direction toward the valve inlet;
the piston including an internal piston chamber, the internal piston chamber having a piston inlet and a piston outlet, the piston inlet located proximate to the valve inlet and the piston outlet located proximate to the valve outlet;
the piston having a sealing head, the sealing head having a head surface, the sealing head of the piston located proximate to the piston inlet, the sealing head including an axial point, the axial point located proximate to the intersection of the valve axis with the head surface of the piston;
a head seat, the head seat including a portion of the head surface of the sealing head of the piston, the head seat located on the piston between the piston inlet and the axial point, and the head seat of the piston sealable upon the valve seat of the valve body with the piston in the closed valve position;
the valve body including an actuation chamber, the actuation chamber having a substantially annular shape around the piston;
the piston including a piston ring, the piston ring abutted against the valve body, and
the piston ring substantially contained within the actuation chamber;
the actuation chamber having a forward chamber and a rearward chamber, the forward chamber and the rearward chamber separated by the piston ring, and the piston ring movable within the actuation chamber as the piston moves along the valve axis; and
the piston actuateable between the open valve position and the closed valve position, by a pressurizing of the rearward chamber.

8. The axial valve of claim 7, wherein;
a fluid flow is receivable into the valve inlet;
the piston inlet receives a fluid flow from the valve inlet into the internal piston chamber;
the fluid flow is dischargeable through the valve outlet; and
the head seat of the piston is sealable upon the valve seat of the valve body with the piston in the closed valve position, to prevent the fluid flow through the axial valve.

9. The axial valve of claim 7, wherein;
the piston of the axial valve is pneumatically actuated between the open valve position and the closed valve position.

10. The axial valve of claim 7, wherein;
the piston inlet is a multiple of piston inlet ports.

11. The axial valve of claim 7, wherein;
the piston inlet port has a cross sectional area normal to a direction of the fluid flow through the piston inlet port, and the valve inlet having a cross sectional area normal to the direction of fluid flow through the valve inlet; and
the cross sectional area normal to a direction of the fluid flow through the inlet piston port is at least the cross sectional area normal to the direction of fluid flow through the valve inlet.

12. The axial valve of claim 11, wherein;
the piston inlet is a multiple of piston inlet ports, and the cross sectional area normal to the direction of fluid flow through the piston inlet port is a sum of each of the cross sectional areas normal to the direction of fluid flow through each piston inlet port.

13. The axial valve of claim 7, wherein;
the piston is movable along the valve axis from the closed valve position, to allow the fluid flow through the axial valve;
the sealing head is substantially conical in shape, and the head seat is a substantially circular surface in form; and
the valve seat is a substantially circular surface in form, to match and seal with the sealing head.

14. An axial valve comprising:
a valve body, the valve body having a valve inlet, a valve outlet, and a valve chamber within the valve body;
a valve axis connecting the valve inlet center and the valve outlet center;
a valve seat, the valve seat within the valve chamber of the valve body, the valve seat positioned proximate to the valve inlet;
a piston contained within the valve chamber of the valve body, the piston movable within the valve chamber, the piston movable within the valve chamber proximately along the valve axis, between an open valve position in a rearward direction toward the valve outlet and a closed valve position in a forward direction toward the valve inlet;
the piston including an internal piston chamber, the internal piston chamber having a piston inlet and a piston outlet, the piston inlet located proximate to the valve inlet and the piston outlet located proximate to the valve outlet;
the piston having a sealing head, the sealing head having a head surface, the sealing head of the piston located proximate to the piston inlet, the sealing head including an axial point, the axial point located proximate to the intersection of the valve axis with the head surface of the piston;
a head seat, the head seat including a portion of the head surface of the sealing head of the piston, the head seat located on the piston between the piston inlet and the axial point, and the head seat of the piston sealable upon the valve seat of the valve body with the piston in the closed valve position; and
the piston actuateable between the open valve position and the closed valve position.

15. The axial valve of claim 14, wherein;
the valve body of the axial valve includes an actuation chamber, the actuation chamber having a substantially annular shape around the piston;
the piston including a piston ring, the piston ring abutted against the valve body, and the piston ring substantially contained within the actuation chamber;
the actuation chamber having a forward chamber and a rearward chamber, the forward chamber and the rearward chamber separated by the piston ring, and the piston ring movable within the actuation chamber as the piston moves along the valve axis; and
the piston is actuateable between the open valve position and the closed valve position, by a pressurizing of the rearward chamber.

16. The axial valve of claim 14, wherein;
a fluid flow is receivable into the valve inlet;
the piston inlet receives a fluid flow from the valve inlet into the internal piston chamber;
the fluid flow is dischargeable through the valve outlet; and
the head seat of the piston is sealable upon the valve seat of the valve body with the piston in the closed valve position, to prevent the fluid flow through the axial valve.

17. The axial valve of claim 14, wherein;
the piston of the axial valve is pneumatically actuated between the open valve position and the closed valve position.

18. The axial valve of claim 14, wherein;
the piston inlet is a multiple of piston inlet ports.

19. The axial valve of claim 14, wherein;
the piston inlet port has a cross sectional area normal to a direction of the fluid flow through the piston inlet port, and the valve inlet having a cross sectional area normal to the direction of fluid flow through the valve inlet; and
the cross sectional area normal to a direction of the fluid flow through the inlet piston port is at least the cross sectional area normal to the direction of fluid flow through the valve inlet.

20. The axial valve of claim 19, wherein;
the piston inlet is a multiple of piston inlet ports, and the cross sectional area normal to the direction of fluid flow through the piston inlet port is at least a sum of each of the cross sectional areas normal to the direction of fluid flow through each of the multiple of piston inlet ports.

21. The axial valve of claim 14, wherein;
the piston is movable along the valve axis from the closed valve position, to allow the fluid flow through the axial valve;
the sealing head is substantially conical in shape, and the head seat is a substantially circular surface in form; and
the valve seat is a substantially circular surface in form, to match and seal with the sealing head.
